(19) United States
(12) Patent Application Publication
(10) Pub. No.: US 2026/0213674 A1
(43) Pub. Date: Jul. 23, 2026

(54) AC-DC CONVERSION CIRCUIT AND METHOD FOR OPERATING AC-DC CONVERSION CIRCUIT

(71) Applicant: DELTA ELECTRONICS, INC., Taoyuan City (TW)

(72) Inventors: Deng-Cyun HUANG, Taoyuan City (TW); Chin-Te KU, Taoyuan City (TW); Yi-Hsun CHIU, Taoyuan City (TW); Wei-Hsin WEN, Taoyuan City (TW); Chia-Hsiong HUANG, Taoyuan City (TW)

(21) Appl. No.: 19/092,479

(22) Filed: Mar. 27, 2025

(30) Foreign Application Priority Data
Jan. 23, 2025 (CN) 202510110149.3

(51) Int. Cl. H02M 7/219; H02M 1/00; H02M 1/084; H02M 1/088

(52) U.S. Cl. CPC H02M 7/219; H02M 1/0009; H02M 1/084; H02M 1/088

(57) ABSTRACT

An AC-DC conversion circuit includes a power measurement circuit, a control circuit, and three bridge arm circuits. Each bridge arm circuit includes a plurality of switches. The power measurement circuit is used to measure at least one of an input power and an output power to generate a power measurement value. When the power measurement value is less than a power threshold value, the control circuit controls the switches of the three bridge arm circuits to set the three bridge arm circuits to operate in a light load mode. When the power measurement value is greater than the power threshold value, the control circuit controls the switches of the three bridge arm circuits to set the three bridge arm circuits to operate in a heavy load mode.

### CROSS-REFERENCE TO RELATED APPLICATION

This patent application claims the benefit of Chinese Patent Application No. 202510110149.3 filed Jan. 23, 2025, which is incorporated by reference herein.

### BACKGROUND OF THE DISCLOSURE

### Technical Field

The present disclosure relates to a conversion circuit and a method for operating the conversion circuit, and especially relates to an AC-DC conversion circuit and a method for operating the AC-DC conversion circuit.

### Description of Related Art

Currently, there are a variety of pulse width modulation modes available for controlling the related art power conversion apparatus (for example, the active neutral point clamped (often abbreviated to ANPC) power conversion apparatus). The power losses of these pulse width modulation modes are different at different powers. The power loss of some pulse width modulation modes is low when the power is less than a specific power but high when the power is greater than or equal to the specific power, while some pulse width modulation modes are just the opposite.

To sum up, the current pulse width modulation modes are not ideal enough, so that controlling the overall power loss of the related art power conversion apparatus using a single pulse width modulation mode at all powers is still not ideal.

### SUMMARY OF THE INVENTION

In order to solve the above-mentioned problems, an object of the present disclosure is to provide an AC-DC conversion circuit.

In order to solve the above-mentioned problems, another object of the present disclosure is to provide a method for operating an AC-DC conversion circuit.

In order to achieve the object of the present disclosure mentioned above, the AC-DC conversion circuit of the present disclosure is used for generating a DC output voltage based on a three-phase AC input power. The AC-DC conversion circuit includes: a power measurement circuit, a control circuit, and three bridge arm circuits. The power measurement circuit is used for measuring at least one of an input power and an output power to generate a power measurement value. The control circuit is coupled to the power measurement circuit. Moreover, each of the three bridge arm circuits includes a first switch, a second switch, a third switch, a fourth switch, a fifth switch, and a sixth switch. The first switch includes a control terminal coupled to the control circuit, a first terminal coupled to a first output terminal through a first capacitor, and a second terminal. The second switch includes a control terminal coupled to the control circuit, a first terminal coupled to the second terminal of the first switch, and a second terminal coupled to a first input inductor. The third switch includes a control terminal coupled to the control circuit, a first terminal coupled to the second terminal of the second switch and the first input inductor, and a second terminal. The fourth switch includes a control terminal coupled to the control circuit, a first terminal coupled to the second terminal of the third switch, and a second terminal coupled to the first output terminal through a second capacitor. The fifth switch includes a control terminal coupled to the control circuit, a first terminal coupled to the second terminal of the first switch and the first terminal of the second switch, and a second terminal coupled to the first output terminal. The sixth switch includes a control terminal coupled to the control circuit, a first terminal coupled to the second terminal of the fifth switch and the first output terminal, and a second terminal coupled to the second terminal of the third switch and the first terminal of the fourth switch. Moreover, when the power measurement value is less than a power threshold value, the control circuit sets the three bridge arm circuits to operate in a light load mode, and: in a first positive half cycle signal of a first single-phase AC power of the three-phase AC input power, the control circuit sets the second switch of a first bridge arm circuit of the three bridge arm circuits coupled to the first single-phase AC power to be conducted, and sets the third switch and the fourth switch of the first bridge arm circuit to be not conducted; in a charging mode of the first positive half cycle signal, the control circuit sets the first switch and the sixth switch of the first bridge arm circuit to be not conducted, and sets the fifth switch of the first bridge arm circuit to be conducted; in a discharging mode of the first positive half cycle signal, the control circuit sets the first switch and the sixth switch of the first bridge arm circuit to be conducted, and sets the fifth switch of the first bridge arm to be not conducted; in a first negative half cycle signal of the first single-phase AC power of the three-phase AC input power, the control circuit sets the first switch and the second switch of the first bridge arm circuit to be not conducted, and sets the third switch of the first bridge arm to be conducted; in a charging mode of the first negative half cycle signal, the control circuit sets the fourth switch and the fifth switch of the first bridge arm circuit to be not conducted, and sets the sixth switch of the first bridge arm to be conducted; in a discharging mode of the first negative half cycle signal, the control circuit sets the fourth switch and the fifth switch of the first bridge arm circuit to be conducted, and sets the sixth switch of the first bridge arm to be not conducted. Moreover, when the power measurement value is greater than the power threshold value, the control circuit sets the three bridge arm circuits to operate in a heavy load mode, and: in a second positive half cycle signal of the first single-phase AC power of the three-phase AC input power, the control circuit sets the second switch and the sixth switch of the first bridge arm circuit to be conducted, and sets the fourth switch of the first bridge arm circuit to be not conducted; in a charging mode of the second positive half cycle signal, the control circuit sets the first switch of the first bridge arm circuit to be not conducted, and sets the third switch and the fifth switch of the first bridge arm circuit to be conducted; in a discharging mode of the second positive half cycle signal, the control circuit sets the first switch of the first bridge arm circuit to be conducted, and sets the third switch and the fifth switch of the first bridge arm circuit to be not conducted; in a second negative half cycle signal of the first single-phase AC power of the three-phase AC input power, the control circuit sets the first switch of the first bridge arm circuit to be not conducted, and sets the third switch and the fifth switch of the first bridge arm circuit to be conducted; in a charging mode of the second negative half cycle signal, the control circuit sets the second switch and the sixth switch of the first bridge arm circuit to be conducted, and sets the fourth switch of the first bridge arm circuit to be not conducted; in a discharging mode of the second negative half cycle signal, the control circuit sets the second switch and the sixth switch of the first bridge arm circuit to be not conducted, and sets the fourth switch of the first bridge arm circuit to be conducted.

In order to achieve the other object of the present disclosure mentioned above, the method of the present disclosure is applied to the AC-DC conversion circuit which generates a DC output voltage based on a three-phase AC input power. The AC-DC conversion circuit includes a power measurement circuit, a control circuit, and three bridge arm circuits. The control circuit is coupled to the power measurement circuit. Each of the three bridge arm circuits includes: a first switch, a second switch, a third switch, a fourth switch, a fifth switch, and a sixth switch. The first switch includes a control terminal coupled to the control circuit, a first terminal coupled to a first output terminal through a first capacitor, and a second terminal. The second switch includes a control terminal coupled to the control circuit, a first terminal coupled to the second terminal of the first switch, and a second terminal coupled to a first input inductor. The third switch includes a control terminal coupled to the control circuit, a first terminal coupled to the second terminal of the second switch and the first input inductor, and a second terminal. The fourth switch includes a control terminal coupled to the control circuit, a first terminal coupled to the second terminal of the third switch, and a second terminal coupled to the first output terminal through a second capacitor. The fifth switch includes a control terminal coupled to the control circuit, a first terminal coupled to the second terminal of the first switch and the first terminal of the second switch, and a second terminal coupled to the first output terminal. The sixth switch includes a control terminal coupled to the control circuit, a first terminal coupled to the second terminal of the fifth switch and the first output terminal, and a second terminal coupled to the second terminal of the third switch and the first terminal of the fourth switch. The method includes following steps. The power measurement circuit measures at least one of an input power and an output power to generate a power measurement value. When the power measurement value is less than a power threshold value, the control circuit sets the three bridge arm circuits to operate in a light load mode, and: in a first positive half cycle signal of a first single-phase AC power of the three-phase AC input power, the control circuit sets the second switch of a first bridge arm circuit of the three bridge arm circuits coupled to the first single-phase AC power to be conducted, and sets the third switch and the fourth switch of the first bridge arm circuit to be not conducted; in a charging mode of the first positive half cycle signal, the control circuit sets the first switch and the sixth switch of the first bridge arm circuit to be not conducted, and sets the fifth switch of the first bridge arm circuit to be conducted; in a discharging mode of the first positive half cycle signal, the control circuit sets the first switch and the sixth switch of the first bridge arm circuit to be conducted, and sets the fifth switch of the first bridge arm to be not conducted; in a first negative half cycle signal of the first single-phase AC power of the three-phase AC input power, the control circuit sets the first switch and the second switch of the first bridge arm circuit to be not conducted, and sets the third switch of the first bridge arm to be conducted; in a charging mode of the first negative half cycle signal, the control circuit sets the fourth switch and the fifth switch of the first bridge arm circuit to be not conducted, and sets the sixth switch of the first bridge arm to be conducted; in a discharging mode of the first negative half cycle signal, the control circuit sets the fourth switch and the fifth switch of the first bridge arm circuit to be conducted, and sets the sixth switch of the first bridge arm to be not conducted. When the power measurement value is greater than the power threshold value, the control circuit sets the three bridge arm circuits to operate in a heavy load mode, and: in a second positive half cycle signal of the first single-phase AC power of the three-phase AC input power, the control circuit sets the second switch and the sixth switch of the first bridge arm circuit to be conducted, and sets the fourth switch of the first bridge arm circuit to be not conducted; in a charging mode of the second positive half cycle signal, the control circuit sets the first switch of the first bridge arm circuit to be not conducted, and sets the third switch and the fifth switch of the first bridge arm circuit to be conducted; in a discharging mode of the second positive half cycle signal, the control circuit sets the first switch of the first bridge arm circuit to be conducted, and sets the third switch and the fifth switch of the first bridge arm circuit to be not conducted; in a second negative half cycle signal of the first single-phase AC power of the three-phase AC input power, the control circuit sets the first switch of the first bridge arm circuit to be not conducted, and sets the third switch and the fifth switch of the first bridge arm circuit to be conducted; in a charging mode of the second negative half cycle signal, the control circuit sets the second switch and the sixth switch of the first bridge arm circuit to be conducted, and sets the fourth switch of the first bridge arm circuit to be not conducted; in a discharging mode of the second negative half cycle signal, the control circuit sets the second switch and the sixth switch of the first bridge arm circuit to be not conducted, and sets the fourth switch of the first bridge arm circuit to be conducted.

The advantage of the present disclosure is to reduce the overall power loss of the AC-DC conversion circuit.

Please refer to the detailed descriptions and figures of the present disclosure mentioned below for further understanding technologies, methods, and effects and achieving the predetermined purposes of the present disclosure. Further, the purposes, characteristics, and features of the present disclosure may be more deeply and specifically understood. However, the drawings are provided only for references and descriptions and not intended to limit the scope of the present disclosure.

### BRIEF DESCRIPTION OF THE DRAWINGS

FIG. 1 shows a circuit block diagram of the first embodiment of the AC-DC conversion circuit of the present disclosure.

FIG. 2 shows a power-power loss comparison diagram of an embodiment of the first pulse width modulation mode and the second pulse width modulation mode of the present disclosure.

FIG. 3 shows a waveform comparison diagram of the present disclosure in the light load mode.

FIG. 4 shows a waveform comparison diagram of the present disclosure in the heavy load mode.

FIG. 5 shows a circuit block diagram of the second embodiment of the AC-DC conversion circuit of the present disclosure.

FIG. 6 shows a circuit block diagram of the third embodiment of the AC-DC conversion circuit of the present disclosure.

FIG. 7 shows a block diagram of an embodiment of the logic circuit of the present disclosure.

FIG. 8 shows a flow chart of a method for operating an AC-DC conversion circuit of the present disclosure.

### DETAILED DESCRIPTION

In the present disclosure, numerous specific details are provided, to provide a comprehensive understanding of embodiments of the present disclosure. However, those skilled in the art may understand that the present disclosure may be practiced without one or more of these specific details. In other instances, well-known details are not shown or described to avoid obscuring features of the present disclosure. The technical content and the detailed description of the present disclosure are as follows with reference to the figures.

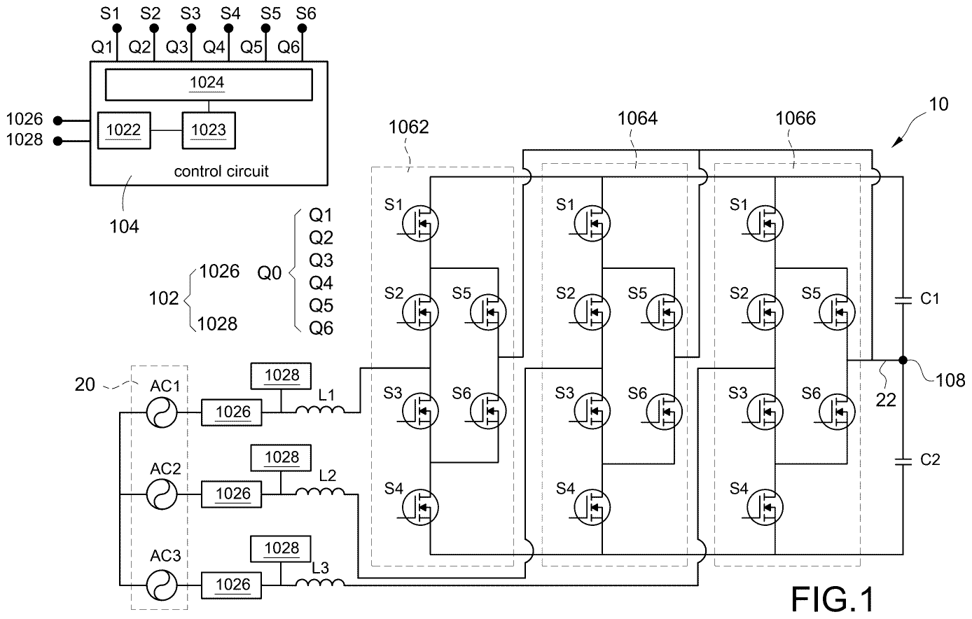

FIG. 1 shows a circuit block diagram of the first embodiment of the AC-DC conversion circuit 10 of the present disclosure. The AC-DC conversion circuit 10 of the present disclosure is used to generate a DC output voltage 22 based on a three-phase AC input power 20. The AC-DC conversion circuit 10 includes a power measurement circuit 102, a control circuit 104, and three bridge arm circuits (namely, a first bridge arm circuit 1062, a second bridge arm circuit 1064, and a third bridge arm circuit 1066). The power measurement circuit 102 includes a plurality of current sensors 1026 and a plurality of voltage sensors 1028. The control circuit 104 includes a power calculation circuit 1022, a power threshold determination circuit 1023, and a control signal generation circuit 1024.

The power calculation circuit 1022 of the control circuit 104 is coupled to the current sensors 1026 and the voltage sensors 1028 of the power measurement circuit 102. To simplify FIG. 1, FIG. 1 omits the connection lines from the power calculation circuit 1022 of the control circuit 104 to the current sensors 1026 and the voltage sensors 1028 of the power measurement circuit 102. At each bridge arm circuit, the current sensor 1026 and the voltage sensor 1028 measure the current and the voltage respectively, so that the power calculation circuit 1022 of the control circuit 104 calculates to obtain the input power (for example, using the formula: the power is equal to the current multiplied by the voltage). The power calculation circuit 1022 may calculate one or more input powers of the three bridge arm circuits (for example, calculating the sum of the input powers of the three bridge arm circuits).

Each of the bridge arm circuits includes a first switch S1, a second switch S2, a third switch S3, a fourth switch S4, a fifth switch S5, and a sixth switch S6; these switches may be transistor switches (for example, all of these switches are N-channel metal oxide semiconductor field effect transistors, NPN bipolar transistors, silicon carbide transistors, gallium nitride transistors, or insulated gate bipolar transistors).

FIG. 1 omits the connection lines from the control signal generation circuit 1024 of the control circuit 104 to the control terminals of all of the switches. Taking the first bridge arm circuit 1062 as an example: the first switch S1 includes a control terminal coupled to the control signal generation circuit 1024 of the control circuit 104, a first terminal coupled to a first output terminal 108 through a first capacitor C1, and a second terminal; the second switch S2 includes a control terminal coupled to the control signal generation circuit 1024 of the control circuit 104, a first terminal coupled to the second terminal of the first switch S1, and a second terminal coupled to a first input inductor L1 (for the second bridge arm circuit 1064, the second terminal is coupled to a second input inductor L2; for the third bridge arm circuit 1066, the second terminal is coupled to a third input inductor L3); the third switch S3 includes a control terminal coupled to the control signal generation circuit 1024 of the control circuit 104, a first terminal coupled to the second terminal of the second switch S2 and the first input inductor L1 (for the second bridge arm circuit 1064, the first terminal is coupled to the second terminal of the second switch S2 and the second input inductor L2; for the third bridge arm circuit 1066, the first terminal is coupled to the second terminal of the second switch S2 and the third input inductor L3), and a second end; the fourth switch S4 includes a control terminal coupled to the control signal generation circuit 1024 of the control circuit 104, a first terminal coupled to the second terminal of the third switch S3, and a second terminal coupled to the first output terminal 108 through a second capacitor C2; the fifth switch S5 includes a control terminal coupled to the control signal generation circuit 1024 of the control circuit 104, a first terminal coupled to the second terminal of the first switch S1 and the first terminal of the second switch S2, and a second terminal coupled to the first output terminal 108; the sixth switch S6 includes a control terminal coupled to the control signal generation circuit 1024 of the control circuit 104, a first terminal coupled to the second terminal of the fifth switch S5 and the first output terminal 108, and a second terminal coupled to the second terminal of the third switch S3 and the first terminal of the fourth switch S4. The AC-DC conversion circuit 10 of the present disclosure may also be called an active neutral point clamped (often abbreviated to ANPC) power conversion apparatus.

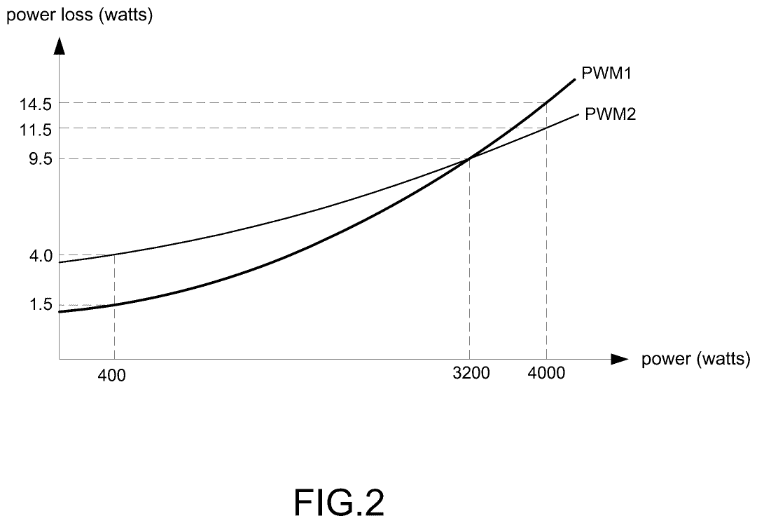

FIG. 2 shows a power-power loss comparison diagram of an embodiment of the first pulse width modulation mode PWM1 and the second pulse width modulation mode PWM2 of the present disclosure. Please also refer to FIG. 1. The present disclosure provides a first pulse width modulation mode PWM1 and a second pulse width modulation mode PWM2 to control the switches to generate the DC output voltage 22 based on the three-phase AC input power 20. FIG. 2 shows an embodiment of the power loss of the AC-DC conversion circuit 10 in the first pulse width modulation mode PWM1 and the power loss of the AC-DC conversion circuit 10 in the second pulse width modulation mode PWM2.

For example, when the power is 400 watts, the power loss of the AC-DC conversion circuit 10 in the first pulse width modulation mode PWM1 is 1.5 watts, and the power loss of the AC-DC conversion circuit 10 in the second pulse width modulation mode PWM2 is 4 watts. When the power is 3200 watts, the power loss of the AC-DC conversion circuit 10 in the first pulse width modulation mode PWM1 is 9.5 watts, and the power loss of the AC-DC conversion circuit 10 in the second pulse width modulation mode PWM2 is also 9.5 watts. When the power is 4000 watts, the power loss of the AC-DC conversion circuit 10 in the first pulse width modulation mode PWM1 is 14.5 watts, and the power loss of the AC-DC conversion circuit 10 in the second pulse width modulation mode PWM2 is 11.5 watts.

It can be seen from the power-power loss comparison diagram shown in FIG. 2 that when the power is less than 3200 watts, the power loss of the AC-DC conversion circuit 10 in the first pulse width modulation mode PWM1 may be less than the power loss of the AC-DC conversion circuit 10 in the second pulse width modulation mode PWM2. However, when the power is greater than or equal to 3200 watts, the power loss of the AC-DC conversion circuit 10 in the second pulse width modulation mode PWM2 may be less than the power loss of the AC-DC conversion circuit 10 in the first pulse width modulation mode PWM1.

Therefore, in the embodiment of FIG. 2, the present disclosure uses the power 3200 watts as the threshold value. When the power is less than 3200 watts, the AC-DC conversion circuit 10 is operated in the first pulse width modulation mode PWM1, and when the power is greater than or equal to 3200 watts, the AC-DC conversion circuit 10 is operated in the second pulse width modulation mode PWM2, thereby minimizing the overall power loss. Therefore, the advantage of the present disclosure is to reduce the overall power loss of the AC-DC conversion circuit 10. In the following content, the first pulse width modulation mode PWM1 is called the light load mode LL, and the second pulse width modulation mode PWM2 is called the heavy load mode HL.

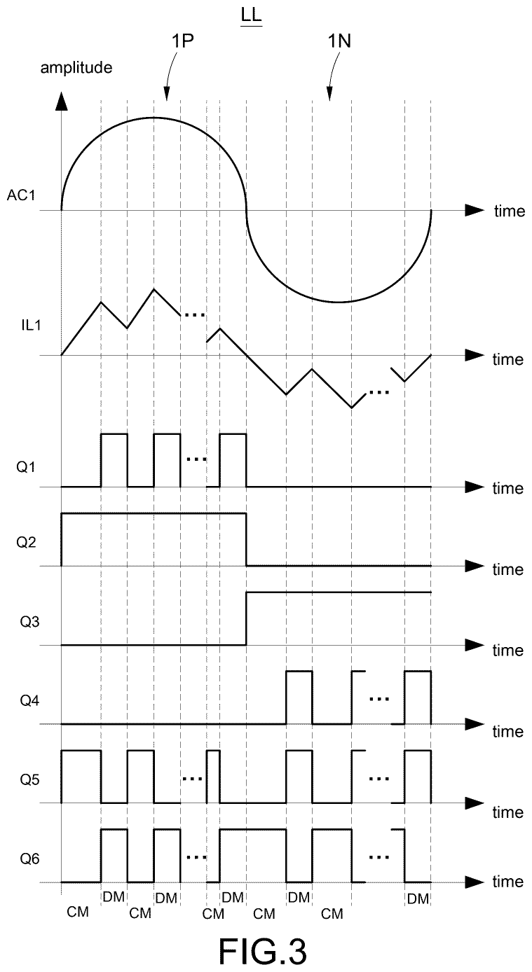

FIG. 3 shows a waveform comparison diagram of the present disclosure in the light load mode LL. Please also refer to FIG. 1. The power threshold determination circuit 1023 of the control circuit 104 is coupled to the power calculation circuit 1022, and compares the input power calculated and obtained by the power calculation circuit 1022 with a power threshold value which is predetermined. When the power threshold determination circuit 1023 determines that the power measurement value is less than the power threshold value (for example, 3200 watts shown in FIG. 2), the control signal generation circuit 1024 of the control circuit 104 correspondingly generates control signals to set the three bridge arm circuits to operate in a light load mode LL (namely, the first pulse width modulation mode PWM1 shown in FIG. 2), which is described in detail below and takes the first bridge arm circuit 1062 as an example. Moreover, the control signal generation circuit 1024 of the control circuit 104 generates a first control signal Q1, a second control signal Q2, a third control signal Q3, a fourth control signal Q4, a fifth control signal Q5, and a sixth control signal Q6 to control the conduction states of the first switch S1, the second switch S2, the third switch S3, the fourth switch S4, the fifth switch S5, and the sixth switch S6 of the first bridge arm circuit 1062 respectively. FIG. 3 further shows a first inductor current IL1 of the first input inductor L1.

In a first positive half cycle signal 1P of a first single-phase AC power AC1 of the three-phase AC input power 20, whether in the charging mode CM (charging the inductor) or the discharging mode DM (the inductor discharging), the control signal generation circuit 1024 of the control circuit 104 sets the second switch S2 of the first bridge arm circuit 1062 coupled to the first single-phase AC power AC1 to be conducted, and sets the third switch S3 and the fourth switch S4 of the first bridge arm circuit 1062 to be not conducted. Moreover, in a charging mode CM of the first positive half cycle signal 1P, the control signal generation circuit 1024 of the control circuit 104 sets the first switch S1 and the sixth switch S6 of the first bridge arm circuit 1062 to be not conducted, and sets the fifth switch S5 of the first bridge arm circuit 1062 to be conducted (wherein the conduction frequency of the fifth switch S5 is different from the conduction frequency of the second switch S2). In a discharging mode DM of the first positive half cycle signal 1P, the control signal generation circuit 1024 of the control circuit 104 sets the first switch S1 and the sixth switch S6 of the first bridge circuit 1062 to be conducted (wherein the conduction frequency of the first switch S1 is the same as the conduction frequency of the sixth switch S6, but different from the conduction frequency of the second switch S2), and sets the fifth switch S5 of the first bridge arm circuit 1062 to be not conducted.

In a first negative half cycle signal 1N of the first single-phase AC power AC1 of the three-phase AC input power 20, whether in the charging mode CM or the discharging mode DM, the control signal generation circuit 1024 of the control circuit 104 sets the first switch S1 and the second switch S2 of the first bridge circuit 1062 to be not conducted, and sets the third switch S3 of the first bridge circuit 1062 to be conducted. Moreover, in a charging mode CM of the first negative half cycle signal 1N, the control signal generation circuit 1024 of the control circuit 104 sets the fourth switch S4 and the fifth switch S5 of the first bridge arm circuit 1062 to be not conducted, and sets the sixth switch S6 of the first bridge arm circuit 1062 to be conducted (wherein the conduction frequency of the sixth switch S6 is different from the conduction frequency of the third switch S3). In a discharging mode DM of the first negative half cycle signal 1N, the control signal generation circuit 1024 of the control circuit 104 sets the fourth switch S4 and the fifth switch S5 of the first bridge arm circuit 1062 to be conducted (wherein the conduction frequency of the fourth switch S4 is the same as the conduction frequency of the fifth switch S5, but different from the conduction frequency of the third switch S3), and sets the sixth switch S6 of the first bridge arm circuit 1062 to be not conducted.

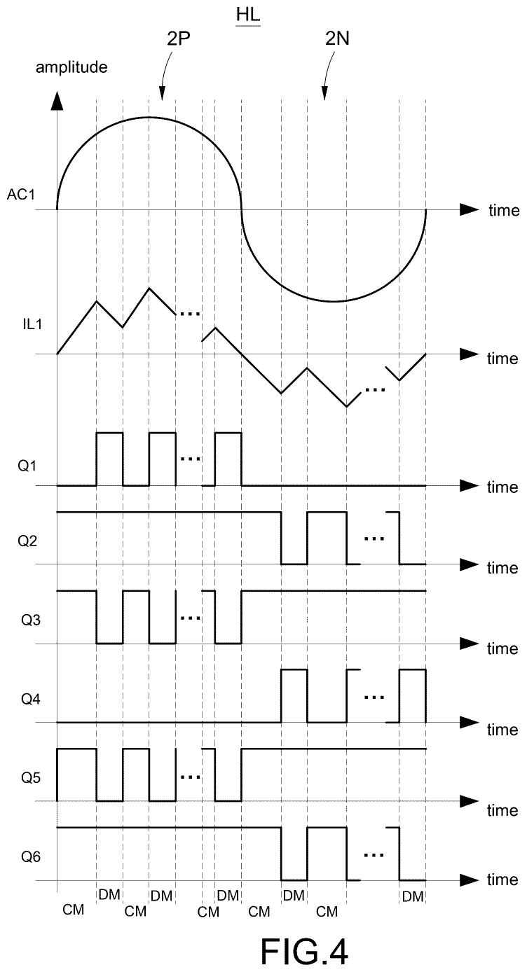

FIG. 4 shows a waveform comparison diagram of the present disclosure in the heavy load mode HL. Please also refer to FIG. 1. When the power measurement value is greater than or equal to the power threshold value, the control signal generation circuit 1024 of the control circuit 104 sets the three bridge arm circuits to operate in a heavy load mode HL (namely, the second pulse width modulation mode PWM2 shown in FIG. 2), which is described in detail below and takes the first bridge arm circuit 1062 as an example.

In a second positive half cycle signal 2P of the first single-phase AC power AC1 of the three-phase AC input power 20, whether in the charging mode CM or the discharging mode DM, the control signal generation circuit 1024 of the control circuit 104 sets the second switch S2 and the sixth switch S6 of the first bridge arm circuit 1062 to be conducted, and sets the fourth switch S4 of the first bridge arm circuit 1062 to be not conducted. Moreover, in a charging mode CM of the second positive half cycle signal 2P, the control signal generation circuit 1024 of the control circuit 104 sets the first switch S1 of the first bridge arm circuit 1062 to be not conducted, and sets the third switch S3 and the fifth switch S5 of the first bridge arm circuit 1062 to be conducted (wherein the conduction frequencies of the second switch S2, the third switch S3, the fifth switch S5, and the sixth switch S6 are all the same; conducting the four switches may share the charging current and reduce the conduction loss). In a discharging mode DM of the second positive half cycle signal 2P, the control signal generation circuit 1024 of the control circuit 104 sets the first switch S1 of the first bridge arm circuit 1062 to be conducted (wherein the conduction frequencies of the first switch S1, the second switch S2, and the sixth switch S6 are all the same), and sets the third switch S3 and the fifth switch S5 of the first bridge arm circuit 1062 to be not conducted.

In a second negative half cycle signal 2N of the first single-phase AC power AC1 of the three-phase AC input power 20, whether in the charging mode CM or the discharging mode DM, the control signal generation circuit 1024 of the control circuit 104 sets the first switch S1 of the first bridge arm circuit 1062 to be not conducted, and sets the third switch S3 and the fifth switch S5 of the first bridge arm circuit 1062 to be conducted. Moreover, in a charging mode CM of the second negative half cycle signal 2N, the control signal generation circuit 1024 of the control circuit 104 sets the second switch S2 and the sixth switch S6 of the first bridge arm circuit 1062 to be conducted (wherein the conduction frequencies of the second switch S2, the third switch S3, the fifth switch S5, and the sixth switch S6 are all the same; conducting the four switches may share the charging current and reduce the conduction loss), and sets the fourth switch S4 of the first bridge arm circuit 1062 to be not conducted. In a discharging mode DM of the second negative half cycle signal 2N, the control signal generation circuit 1024 of the control circuit 104 sets the second switch S2 and the sixth switch S6 of the first bridge arm circuit 1062 to be not conducted, and sets the fourth switch S4 of the first bridge arm circuit 1062 to be conducted (wherein the conduction frequencies of the third switch S3, the fourth switch S4, and the fifth switch S5 are all the same).

The operations of the bridge arm circuits for each phase are similar or identical (which therefore are not described again here), but the phase difference is 120 degrees; namely, phase differences of the first single-phase AC power AC1, a second single-phase AC power AC2, and a third single-phase AC power AC3 of the three-phase AC input power 20 are 120 degrees respectively; the control signal generation circuit 1024 of the control circuit 104 sets phase differences of control signals Q0 for the three bridge arm circuits to 120 degrees respectively, wherein the control signals Q0 are the first control signal Q1, the second control signal Q2, the third control signal Q3, the fourth control signal Q4, the fifth control signal Q5, and the sixth control signal Q6.

For example, in the charging mode CM, when the first bridge arm circuit 1062 is in the first positive half cycle signal 1P of the first single-phase AC power AC1, the second bridge arm circuit 1064 may also be in the first positive half cycle signal 1P of the second single-phase AC power AC2, and the third bridge arm circuit 1066 may be in the first negative half cycle signal 1N of the third single-phase AC power AC3. Therefore, as mentioned above, the second switch S2 and the fifth switch S5 of the first bridge arm circuit 1062 are conducted, and the second switch S2 and the fifth switch S5 of the second bridge arm circuit 1064 are also conducted, and the third switch S3 and the sixth switch S6 of the third bridge arm circuit 1066 are conducted.

When the input power is less than the power threshold value, the power measurement circuit 102 and the control signal generation circuit 1024 of the control circuit 104 set the power measurement value to a low potential, so that the control signal generation circuit 1024 of the control circuit 104 sets the three bridge arm circuits to operate in the light load mode LL. When the input power is greater than or equal to the power threshold value, the power measurement circuit 102 and the control signal generation circuit 1024 of the control circuit 104 set the power measurement value to a high potential, so that the control signal generation circuit 1024 of the control circuit 104 sets the three bridge arm circuits to operate in the heavy load mode HL.

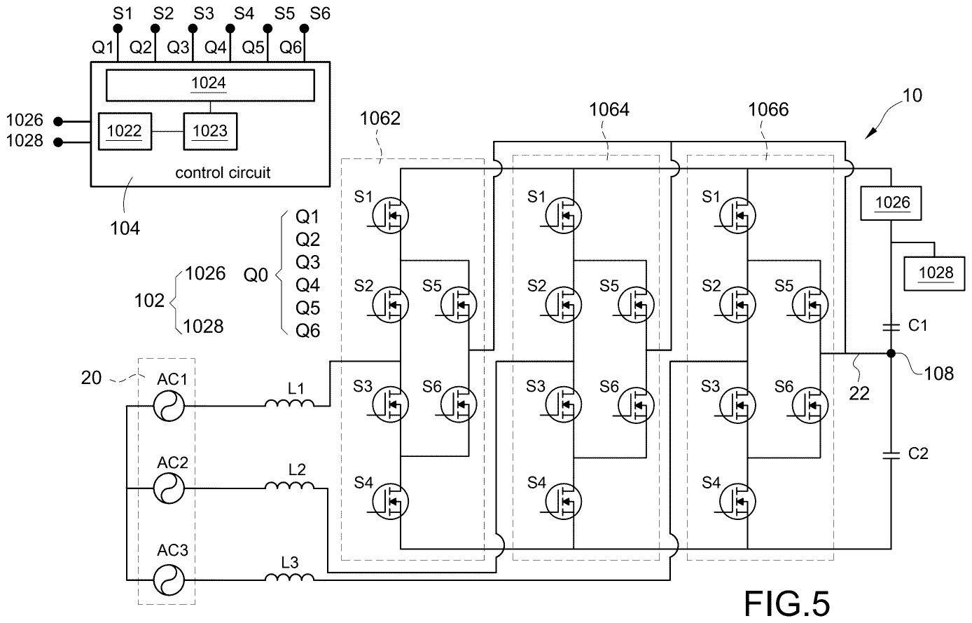

FIG. 5 shows a circuit block diagram of the second embodiment of the AC-DC conversion circuit 10 of the present disclosure. The descriptions of the elements shown in FIG. 5 which are the same as the elements shown in FIG. 1 are not repeated here for brevity. Different from FIG. 1, the current sensor 1026 and the voltage sensor 1028 of the power measurement circuit 102 of FIG. 5 are used to measure an output power to generate the power measurement value; namely, the power measurement circuit 102 of the present disclosure is used to measure at least one of the input power (shown in FIG. 1) and the output power (shown in FIG. 5) to generate the power measurement value.

When the output power is less than the power threshold value, the power measurement circuit 102 and the control signal generation circuit 1024 of the control circuit 104 set the power measurement value to a low potential, so that the control signal generation circuit 1024 of the control circuit 104 sets the three bridge arm circuits to operate in the light load mode LL. When the output power is greater than or equal to the power threshold value, the power measurement circuit 102 and the control signal generation circuit 1024 of the control circuit 104 set the power measurement value to a high potential, so that the control signal generation circuit 1024 of the control circuit 104 sets the three bridge arm circuits to operate in the heavy load mode HL.

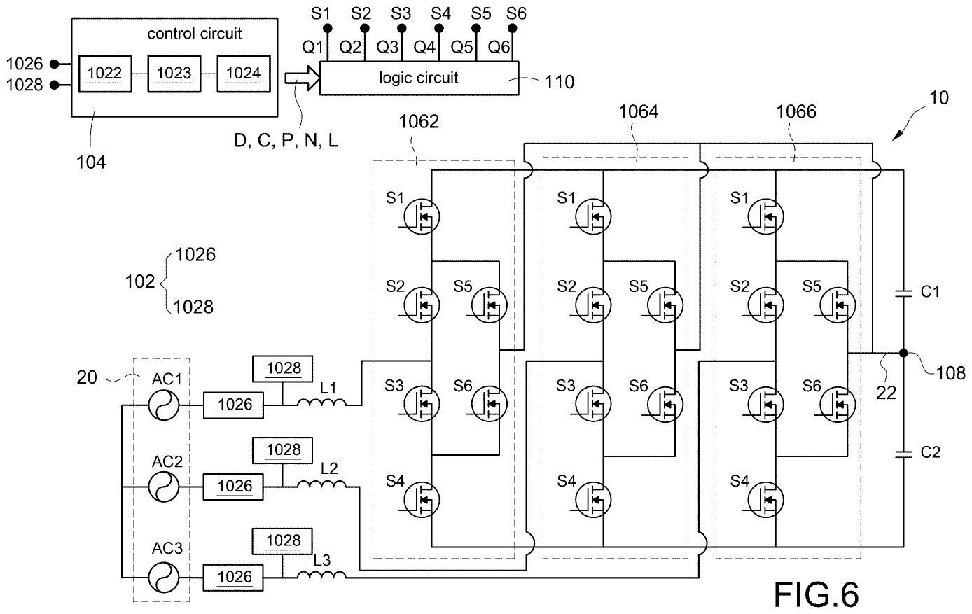

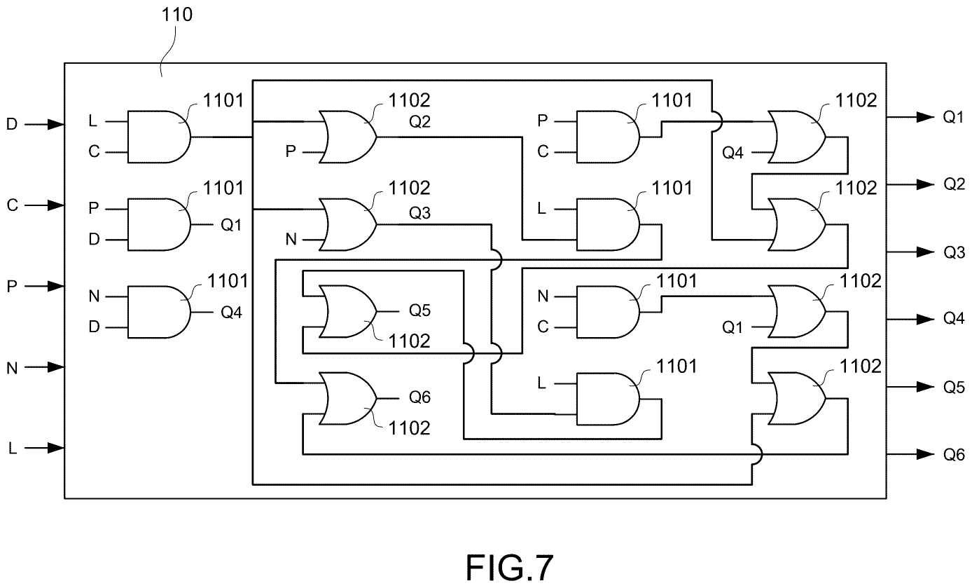

FIG. 6 shows a circuit block diagram of the third embodiment of the AC-DC conversion circuit 10 of the present disclosure. The descriptions of the elements shown in FIG. 6 which are the same as the elements shown in FIG. 1 are not repeated here for brevity. FIG. 7 shows a block diagram of an embodiment of the logic circuit 110 of the present disclosure. Please refer to both FIG. 6 and FIG. 7. Different from FIG. 1, the AC-DC conversion circuit 10 of FIG. 6 further includes a logic circuit 110. The logic circuit 110 includes a plurality of AND gates 1101 and a plurality of OR gates 1102. To simplify FIG. 6, the connection lines from the logic circuit 110 to the control terminals of all of the switches are omitted in FIG. 6.

In the embodiment of FIG. 7, the logic circuit 110 correspondingly generates a first control signal Q1, a second control signal Q2, a third control signal Q3, a fourth control signal Q4, a fifth control signal Q5, and a sixth control signal Q6 based on a discharging pulse width modulation signal D, a charging pulse width modulation signal C, a positive half cycle pulse width modulation signal P, and a negative half cycle pulse width modulation signal N generated by the control signal generation circuit 1024 of the control circuit 104 and based on the power measurement value (wherein the symbol of the power measurement value in the following logical relationships is L), to control conduction states of the first switch S1, the second switch S2, the third switch S3, the fourth switch S4, the fifth switch S5, and the sixth switch S6 of the first bridge arm circuit 1062 respectively, wherein the logical relationships between the above signals, values and conduction states are:
Q1=P and D
Q2=(L and C) or P
Q3=(L and C) or N
Q4=N and D
Q5=Q4 or (L and Q3) or (P and C) or (L and C)
Q6=Q1 or (L and Q2) or (N and C) or (L and C)

In the charging mode CM of the first positive half cycle signal 1P, in the charging mode CM of the first negative half cycle signal 1N, in the charging mode CM of the second positive half cycle signal 2P, and in the charging mode CM of the second negative half cycle signal 2N, the control signal generation circuit 1024 of the control circuit 104 sets the charging pulse width modulation signal C to a high potential and the discharging pulse width modulation signal D to a low potential. In the discharging mode DM of the first positive half cycle signal 1P, in the discharging mode DM of the first negative half cycle signal 1N, in the discharging mode DM of the second positive half cycle signal 2P, and in the discharging mode DM of the second negative half cycle signal 2N, the control signal generation circuit 1024 of the control circuit 104 sets the charging pulse width modulation signal C to a low potential and the discharging pulse width modulation signal D to a high potential. In the first positive half cycle signal 1P of the first single-phase AC power AC1 of the three-phase AC input power 20 and in the second positive half cycle signal 2P of the first single-phase AC power AC1 of the three-phase AC input power 20, the control signal generation circuit 1024 of the control circuit 104 sets the positive half cycle pulse width modulation signal P to a high potential and the negative half cycle pulse width modulation signal N to a low potential. In the first negative half cycle signal 1N of the first single-phase AC power AC1 of the three-phase AC input power 20 and in the second negative half cycle signal 2N of the first single-phase AC power AC1 of the three-phase AC input power 20, the control signal generation circuit 1024 of the control circuit 104 sets the positive half cycle pulse width modulation signal P to a low potential and the negative half cycle pulse width modulation signal N to a high potential. When the power measurement value (L) is a low potential, the control signal generation circuit 1024 of the control circuit 104 sets the three bridge arm circuits to operate in the light load mode LL. When the power measurement value (L) is a high potential, the control signal generation circuit 1024 of the control circuit 104 sets the three bridge arm circuits to operate in the heavy load mode HL.

The control circuit 104 of the present disclosure may be a digital signal processor. In the embodiments of FIG. 1 and FIG. 5, the control circuit 104 needs to output a total of eighteen pulse width modulation signals (namely, signal channels) to control all eighteen switches. Therefore, the design of the control circuit 104 is relatively complex and expensive, which is a high-end digital signal processor. In the embodiment of FIG. 6, for a bridge arm circuit, the control circuit 104 needs to output four pulse width modulation signals (namely, the discharging pulse width modulation signal D, the charging pulse width modulation signal C, the positive half cycle pulse width modulation signal P, and the negative half cycle pulse width modulation signal N) and a GPIO signal (namely, the power measurement value (L)) to control the six switches of a bridge arm circuit; the three bridge arm circuits may share the GPIO signal; therefore, the control circuit 104 only needs to output twelve pulse width modulation signals (4*3=12) plus a GPIO signal to control all eighteen switches of the three bridge arm circuits. Therefore, the design of the control circuit 104 is relatively simple and low-priced, which is a middle-low-end digital signal processor. Therefore, the advantage of the embodiment of FIG. 6 is to reduce the cost of the control circuit 104.

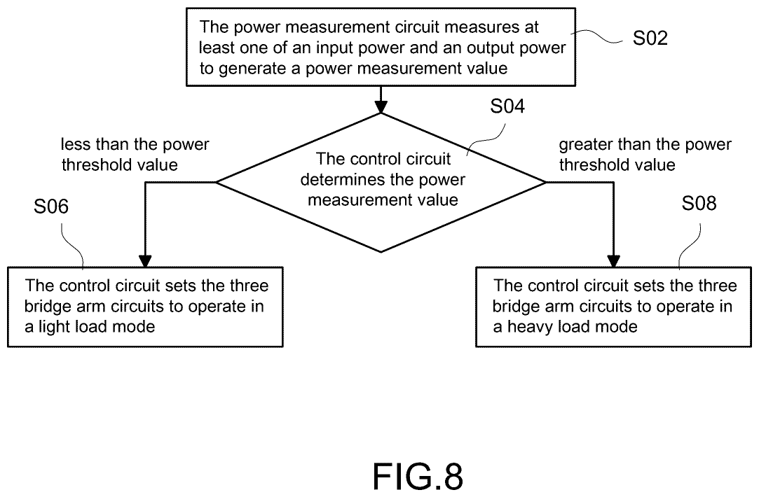

FIG. 8 shows a flow chart of a method for operating an AC-DC conversion circuit of the present disclosure. The method of the present disclosure is applied to an AC-DC conversion circuit which generates a DC output voltage based on a three-phase AC input power. The AC-DC conversion circuit includes a power measurement circuit, a control circuit, and three bridge arm circuits. The control circuit is coupled to the power measurement circuit. Each of the three bridge arm circuits includes a first switch, a second switch, a third switch, a fourth switch, a fifth switch, and a sixth switch.

The first switch includes a control terminal coupled to the control circuit, a first terminal coupled to a first output terminal through a first capacitor, and a second terminal. The second switch includes a control terminal coupled to the control circuit, a first terminal coupled to the second terminal of the first switch, and a second terminal coupled to a first input inductor. The third switch includes a control terminal coupled to the control circuit, a first terminal coupled to the second terminal of the second switch and the first input inductor, and a second terminal. The fourth switch includes a control terminal coupled to the control circuit, a first terminal coupled to the second terminal of the third switch, and a second terminal coupled to the first output terminal through a second capacitor. The fifth switch includes a control terminal coupled to the control circuit, a first terminal coupled to the second terminal of the first switch and the first terminal of the second switch, and a second terminal coupled to the first output terminal. The sixth switch includes a control terminal coupled to the control circuit, a first terminal coupled to the second terminal of the fifth switch and the first output terminal, and a second terminal coupled to the second terminal of the third switch and the first terminal of the fourth switch.

The method includes following steps.
Step S02: The power measurement circuit measures at least one of an input power and an output power to generate a power measurement value. Then, the method enters Step S04.
Step S04: The control circuit determines the power measurement value. When the power measurement value is less than a power threshold value, the method enters Step S06. When the power measurement value is greater than (or equal to) the power threshold value, the method enters Step S08.
Step S06: The control circuit sets the three bridge arm circuits to operate in a light load mode. Step S06 specifically includes the following content. In a first positive half cycle signal of a first single-phase AC power of the three-phase AC input power, the control circuit sets the second switch of a first bridge arm circuit of the three bridge arm circuits coupled to the first single-phase AC power to be conducted, and sets the third switch and the fourth switch of the first bridge arm circuit to be not conducted; in a charging mode of the first positive half cycle signal, the control circuit sets the first switch and the sixth switch of the first bridge arm circuit to be not conducted, and sets the fifth switch of the first bridge arm circuit to be conducted; in a discharging mode of the first positive half cycle signal, the control circuit sets the first switch and the sixth switch of the first bridge arm circuit to be conducted, and sets the fifth switch of the first bridge arm to be not conducted; in a first negative half cycle signal of the first single-phase AC power of the three-phase AC input power, the control circuit sets the first switch and the second switch of the first bridge arm circuit to be not conducted, and sets the third switch of the first bridge arm to be conducted; in a charging mode of the first negative half cycle signal, the control circuit sets the fourth switch and the fifth switch of the first bridge arm circuit to be not conducted, and sets the sixth switch of the first bridge arm to be conducted; in a discharging mode of the first negative half cycle signal, the control circuit sets the fourth switch and the fifth switch of the first bridge arm circuit to be conducted, and sets the sixth switch of the first bridge arm to be not conducted.
Step S08: The control circuit sets the three bridge arm circuits to operate in a heavy load mode. Step S08 specifically includes the following content. In a second positive half cycle signal of the first single-phase AC power of the three-phase AC input power, the control circuit sets the second switch and the sixth switch of the first bridge arm circuit to be conducted, and sets the fourth switch of the first bridge arm circuit to be not conducted; in a charging mode of the second positive half cycle signal, the control circuit sets the first switch of the first bridge arm circuit to be not conducted, and sets the third switch and the fifth switch of the first bridge arm circuit to be conducted; in a discharging mode of the second positive half cycle signal, the control circuit sets the first switch of the first bridge arm circuit to be conducted, and sets the third switch and the fifth switch of the first bridge arm circuit to be not conducted; in a second negative half cycle signal of the first single-phase AC power of the three-phase AC input power, the control circuit sets the first switch of the first bridge arm circuit to be not conducted, and sets the third switch and the fifth switch of the first bridge arm circuit to be conducted; in a charging mode of the second negative half cycle signal, the control circuit sets the second switch and the sixth switch of the first bridge arm circuit to be conducted, and sets the fourth switch of the first bridge arm circuit to be not conducted; in a discharging mode of the second negative half cycle signal, the control circuit sets the second switch and the sixth switch of the first bridge arm circuit to be not conducted, and sets the fourth switch of the first bridge arm circuit to be conducted.

Moreover, phase differences of the first single-phase AC power, a second single-phase AC power, and a third single-phase AC power of the three-phase AC input power are 120 degrees respectively, and the control circuit sets phase differences of control signals for the three bridge arm circuits to 120 degrees respectively.

In an embodiment, when the input power is less than the power threshold value, the power measurement circuit sets the power measurement value to a low potential, causing the control circuit to set the three bridge arm circuits to operate in the light load mode; when the input power is greater than or equal to the power threshold value, the power measurement circuit sets the power measurement value to a high potential, causing the control circuit to set the three bridge arm circuits to operate in the heavy load mode.

In another embodiment, when the output power is less than the power threshold value, the power measurement circuit sets the power measurement value to a low potential, causing the control circuit to set the three bridge arm circuits to operate in the light load mode; when the output power is greater than or equal to the power threshold value, the power measurement circuit sets the power measurement value to a high potential, causing the control circuit to set the three bridge arm circuits to operate in the heavy load mode.

Moreover, the AC-DC conversion circuit further includes a logic circuit. The logic circuit correspondingly generates a first control signal (Q1), a second control signal (Q2), a third control signal (Q3), a fourth control signal (Q4), a fifth control signal (Q5), and a sixth control signal (Q6) based on a discharging pulse width modulation signal (D), a charging pulse width modulation signal (C), a positive half cycle pulse width modulation signal (P), and a negative half cycle pulse width modulation signal (N) generated by the control circuit and based on the power measurement value (L), to control conduction states of the first switch, the second switch, the third switch, the fourth switch, the fifth switch, and the sixth switch of the first bridge arm circuit respectively, wherein:
Q1=P and D
Q2=(L and C) or P
Q3=(L and C) or N
Q4=N and D
Q5=Q4 or (L and Q3) or (P and C) or (L and C)
Q6=Q1 or (L and Q2) or (N and C) or (L and C)

Moreover, in the charging mode of the first positive half cycle signal, in the charging mode of the first negative half cycle signal, in the charging mode of the second positive half cycle signal, and in the charging mode of the second negative half cycle signal, the control circuit sets the charging pulse width modulation signal (C) to a high potential and the discharging pulse width modulation signal (D) to a low potential. In the discharging mode of the first positive half cycle signal, in the discharging mode of the first negative half cycle signal, in the discharging mode of the second positive half cycle signal, and in the discharging mode of the second negative half cycle signal, the control circuit sets the charging pulse width modulation signal (C) to a low potential and the discharging pulse width modulation signal (D) to a high potential. In the first positive half cycle signal of the first single-phase AC power of the three-phase AC input power and in the second positive half cycle signal of the first single-phase AC power of the three-phase AC input power, the control circuit sets the positive half cycle pulse width modulation signal (P) to a high potential and the negative half cycle pulse width modulation signal (N) to a low potential. In the first negative half cycle signal of the first single-phase AC power of the three-phase AC input power and in the second negative half cycle signal of the first single-phase AC power of the three-phase AC input power, the control circuit sets the positive half cycle pulse width modulation signal (P) to a low potential and the negative half cycle pulse width modulation signal (N) to a high potential. When the power measurement value (L) is a low potential, the control circuit sets the three bridge arm circuits to operate in the light load mode. When the power measurement value (L) is a high potential, the control circuit sets the three bridge arm circuits to operate in the heavy load mode.

The remaining technical contents of the method of the present disclosure are similar to the technical contents of the AC-DC conversion circuit 10 of the present disclosure mentioned above, and therefore are not described again here.

Although the present disclosure has been described with reference to the embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure.

What is claimed is:

1. An AC-DC conversion circuit for generating a DC output voltage based on a three-phase AC input power, comprising:
a power measurement circuit for measuring at least one of an input power and an output power to generate a power measurement value;
a control circuit coupled to the power measurement circuit; and
three bridge arm circuits, wherein each of the three bridge arm circuits comprises:
a first switch comprising a control terminal coupled to the control circuit, a first terminal coupled to a first output terminal through a first capacitor, and a second terminal;
a second switch comprising a control terminal coupled to the control circuit, a first terminal coupled to the second terminal of the first switch, and a second terminal coupled to a first input inductor;
a third switch comprising a control terminal coupled to the control circuit, a first terminal coupled to the second terminal of the second switch and the first input inductor, and a second terminal;
a fourth switch comprising a control terminal coupled to the control circuit, a first terminal coupled to the second terminal of the third switch, and a second terminal coupled to the first output terminal through a second capacitor;
a fifth switch comprising a control terminal coupled to the control circuit, a first terminal coupled to the second terminal of the first switch and the first terminal of the second switch, and a second terminal coupled to the first output terminal; and
a sixth switch comprising a control terminal coupled to the control circuit, a first terminal coupled to the second terminal of the fifth switch and the first output terminal, and a second terminal coupled to the second terminal of the third switch and the first terminal of the fourth switch,
wherein when the power measurement value is less than a power threshold value, the control circuit sets the three bridge arm circuits to operate in a light load mode, and:
in a first positive half cycle signal of a first single-phase AC power of the three-phase AC input power, the control circuit sets the second switch of a first bridge arm circuit of the three bridge arm circuits coupled to the first single-phase AC power to be conducted, and sets the third switch and the fourth switch of the first bridge arm circuit to be not conducted; in a charging mode of the first positive half cycle signal, the control circuit sets the first switch and the sixth switch of the first bridge arm circuit to be not conducted, and sets the fifth switch of the first bridge arm circuit to be conducted; in a discharging mode of the first positive half cycle signal, the control circuit sets the first switch and the sixth switch of the first bridge arm circuit to be conducted, and sets the fifth switch of the first bridge arm to be not conducted;
in a first negative half cycle signal of the first single-phase AC power of the three-phase AC input power, the control circuit sets the first switch and the second switch of the first bridge arm circuit to be not conducted, and sets the third switch of the first bridge arm to be conducted; in a charging mode of the first negative half cycle signal, the control circuit sets the fourth switch and the fifth switch of the first bridge arm circuit to be not conducted, and sets the sixth switch of the first bridge arm to be conducted; in a discharging mode of the first negative half cycle signal, the control circuit sets the fourth switch and the fifth switch of the first bridge arm circuit to be conducted, and sets the sixth switch of the first bridge arm to be not conducted;
wherein when the power measurement value is greater than the power threshold value, the control circuit sets the three bridge arm circuits to operate in a heavy load mode, and:
in a second positive half cycle signal of the first single-phase AC power of the three-phase AC input power, the control circuit sets the second switch and the sixth switch of the first bridge arm circuit to be conducted, and sets the fourth switch of the first bridge arm circuit to be not conducted; in a charging mode of the second positive half cycle signal, the control circuit sets the first switch of the first bridge arm circuit to be not conducted, and sets the third switch and the fifth switch of the first bridge arm circuit to be conducted; in a discharging mode of the second positive half cycle signal, the control circuit sets the first switch of the first bridge arm circuit to be conducted, and sets the third switch and the fifth switch of the first bridge arm circuit to be not conducted;
in a second negative half cycle signal of the first single-phase AC power of the three-phase AC input power, the control circuit sets the first switch of the first bridge arm circuit to be not conducted, and sets the third switch and the fifth switch of the first bridge arm circuit to be conducted; in a charging mode of the second negative half cycle signal, the control circuit sets the second switch and the sixth switch of the first bridge arm circuit to be conducted, and sets the fourth switch of the first bridge arm circuit to be not conducted; in a discharging mode of the second negative half cycle signal, the control circuit sets the second switch and the sixth switch of the first bridge arm circuit to be not conducted, and sets the fourth switch of the first bridge arm circuit to be conducted.

2. The AC-DC conversion circuit of the claim 1, wherein phase differences of the first single-phase AC power, a second single-phase AC power, and a third single-phase AC power of the three-phase AC input power are 120 degrees respectively, and the control circuit sets phase differences of control signals for the three bridge arm circuits to 120 degrees respectively.

3. The AC-DC conversion circuit of the claim 1, wherein when the input power is less than the power threshold value, the power measurement circuit sets the power measurement value to a low potential, causing the control circuit to set the three bridge arm circuits to operate in the light load mode; when the input power is greater than or equal to the power threshold value, the power measurement circuit sets the power measurement value to a high potential, causing the control circuit to set the three bridge arm circuits to operate in the heavy load mode.

4. The AC-DC conversion circuit of the claim 1, wherein when the output power is less than the power threshold value, the power measurement circuit sets the power measurement value to a low potential, causing the control circuit to set the three bridge arm circuits to operate in the light load mode; when the output power is greater than or equal to the power threshold value, the power measurement circuit sets the power measurement value to a high potential, causing the control circuit to set the three bridge arm circuits to operate in the heavy load mode.

5. The AC-DC conversion circuit of the claim 1, further comprising a logic circuit, wherein the logic circuit correspondingly generates a first control signal (Q1), a second control signal (Q2), a third control signal (Q3), a fourth control signal (Q4), a fifth control signal (Q5), and a sixth control signal (Q6) based on a discharging pulse width modulation signal (D), a charging pulse width modulation signal (C), a positive half cycle pulse width modulation signal (P), and a negative half cycle pulse width modulation signal (N) generated by the control circuit and based on the power measurement value (L), to control conduction states of the first switch, the second switch, the third switch, the fourth switch, the fifth switch, and the sixth switch of the first bridge arm circuit respectively, wherein:
Q1=P and D
Q2=(L and C) or P
Q3=(L and C) or N
Q4=N and D
Q5=Q4 or (L and Q3) or (P and C) or (L and C)
Q6=Q1 or (L and Q2) or (N and C) or (L and C)
wherein in the charging mode of the first positive half cycle signal, in the charging mode of the first negative half cycle signal, in the charging mode of the second positive half cycle signal, and in the charging mode of the second negative half cycle signal, the control circuit sets the charging pulse width modulation signal (C) to a high potential and the discharging pulse width modulation signal (D) to a low potential; in the discharging mode of the first positive half cycle signal, in the discharging mode of the first negative half cycle signal, in the discharging mode of the second positive half cycle signal, and in the discharging mode of the second negative half cycle signal, the control circuit sets the charging pulse width modulation signal (C) to a low potential and the discharging pulse width modulation signal (D) to a high potential; in the first positive half cycle signal of the first single-phase AC power of the three-phase AC input power and in the second positive half cycle signal of the first single-phase AC power of the three-phase AC input power, the control circuit sets the positive half cycle pulse width modulation signal (P) to a high potential and the negative half cycle pulse width modulation signal (N) to a low potential; in the first negative half cycle signal of the first single-phase AC power of the three-phase AC input power and in the second negative half cycle signal of the first single-phase AC power of the three-phase AC input power, the control circuit sets the positive half cycle pulse width modulation signal (P) to a low potential and the negative half cycle pulse width modulation signal (N) to a high potential; when the power measurement value (L) is a low potential, the control circuit sets the three bridge arm circuits to operate in the light load mode; when the power measurement value (L) is a high potential, the control circuit sets the three bridge arm circuits to operate in the heavy load mode.

6. A method for operating an AC-DC conversion circuit to generate a DC output voltage based on a three-phase AC input power, wherein the AC-DC conversion circuit comprises a power measurement circuit, a control circuit, and three bridge arm circuits, the control circuit is coupled to the power measurement circuit, and each of the three bridge arm circuits comprises:
a first switch comprising a control terminal coupled to the control circuit, a first terminal coupled to a first output terminal through a first capacitor, and a second terminal;
a second switch comprising a control terminal coupled to the control circuit, a first terminal coupled to the second terminal of the first switch, and a second terminal coupled to a first input inductor;
a third switch comprising a control terminal coupled to the control circuit, a first terminal coupled to the second terminal of the second switch and the first input inductor, and a second terminal;
a fourth switch comprising a control terminal coupled to the control circuit, a first terminal coupled to the second terminal of the third switch, and a second terminal coupled to the first output terminal through a second capacitor;
a fifth switch comprising a control terminal coupled to the control circuit, a first terminal coupled to the second terminal of the first switch and the first terminal of the second switch, and a second terminal coupled to the first output terminal; and
a sixth switch comprising a control terminal coupled to the control circuit, a first terminal coupled to the second terminal of the fifth switch and the first output terminal, and a second terminal coupled to the second terminal of the third switch and the first terminal of the fourth switch,
the method comprising:
measuring at least one of an input power and an output power by the power measurement circuit to generate a power measurement value;
setting the three bridge arm circuits to operate in a light load mode by the control circuit when the power measurement value is less than a power threshold value, and:
setting the second switch of a first bridge arm circuit of the three bridge arm circuits coupled to a first single-phase AC power to be conducted by the control circuit, and setting the third switch and the fourth switch of the first bridge arm circuit to be not conducted by the control circuit, in a first positive half cycle signal of the first single-phase AC power of the three-phase AC input power; setting the first switch and the sixth switch of the first bridge arm circuit to be not conducted by the control circuit, and setting the fifth switch of the first bridge arm circuit to be conducted by the control circuit, in a charging mode of the first positive half cycle signal; setting the first switch and the sixth switch of the first bridge arm circuit to be conducted by the control circuit, and setting the fifth switch of the first bridge arm to be not conducted by the control circuit, in a discharging mode of the first positive half cycle signal;
setting the first switch and the second switch of the first bridge arm circuit to be not conducted by the control circuit, and setting the third switch of the first bridge arm to be conducted by the control circuit, in a first negative half cycle signal of the first single-phase AC power of the three-phase AC input power; setting the fourth switch and the fifth switch of the first bridge arm circuit to be not conducted by the control circuit, and setting the sixth switch of the first bridge arm to be conducted by the control circuit, in a charging mode of the first negative half cycle signal; setting the fourth switch and the fifth switch of the first bridge arm circuit to be conducted by the control circuit, and setting the sixth switch of the first bridge arm to be not conducted by the control circuit, in a discharging mode of the first negative half cycle signal;
setting the three bridge arm circuits to operate in a heavy load mode by the control circuit when the power measurement value is greater than the power threshold value, and:
setting the second switch and the sixth switch of the first bridge arm circuit to be conducted by the control circuit, and setting the fourth switch of the first bridge arm circuit to be not conducted by the control circuit, in a second positive half cycle signal of the first single-phase AC power of the three-phase AC input power; setting the first switch of the first bridge arm circuit to be not conducted by the control circuit, and setting the third switch and the fifth switch of the first bridge arm circuit to be conducted by the control circuit, in a charging mode of the second positive half cycle signal; setting the first switch of the first bridge arm circuit to be conducted by the control circuit, and setting the third switch and the fifth switch of the first bridge arm circuit to be not conducted by the control circuit, in a discharging mode of the second positive half cycle signal;
setting the first switch of the first bridge arm circuit to be not conducted by the control circuit, and setting the third switch and the fifth switch of the first bridge arm circuit to be conducted by the control circuit, in a second negative half cycle signal of the first single-phase AC power of the three-phase AC input power; setting the second switch and the sixth switch of the first bridge arm circuit to be conducted by the control circuit, and setting the fourth switch of the first bridge arm circuit to be not conducted by the control circuit, in a charging mode of the second negative half cycle signal; setting the second switch and the sixth switch of the first bridge arm circuit to be not conducted by the control circuit, and setting the fourth switch of the first bridge arm circuit to be conducted by the control circuit, in a discharging mode of the second negative half cycle signal.

7. The method of the claim 6, wherein phase differences of the first single-phase AC power, a second single-phase AC power, and a third single-phase AC power of the three-phase AC input power are 120 degrees respectively, and the control circuit sets phase differences of control signals for the three bridge arm circuits to 120 degrees respectively.

8. The method of the claim 6, wherein when the input power is less than the power threshold value, the power measurement circuit sets the power measurement value to a low potential, causing the control circuit to set the three bridge arm circuits to operate in the light load mode; when the input power is greater than or equal to the power threshold value, the power measurement circuit sets the power measurement value to a high potential, causing the control circuit to set the three bridge arm circuits to operate in the heavy load mode.

9. The method of the claim 6, wherein when the output power is less than the power threshold value, the power measurement circuit sets the power measurement value to a low potential, causing the control circuit to set the three bridge arm circuits to operate in the light load mode; when the output power is greater than or equal to the power threshold value, the power measurement circuit sets the power measurement value to a high potential, causing the control circuit to set the three bridge arm circuits to operate in the heavy load mode.

10. The method of the claim 6, wherein the AC-DC conversion circuit further comprises a logic circuit; the logic circuit correspondingly generates a first control signal (Q1), a second control signal (Q2), a third control signal (Q3), a fourth control signal (Q4), a fifth control signal (Q5), and a sixth control signal (Q6) based on a discharging pulse width modulation signal (D), a charging pulse width modulation signal (C), a positive half cycle pulse width modulation signal (P), and a negative half cycle pulse width modulation signal (N) generated by the control circuit and based on the power measurement value (L), to control conduction states of the first switch, the second switch, the third switch, the fourth switch, the fifth switch, and the sixth switch of the first bridge arm circuit respectively, wherein:
Q1=P and D
Q2=(L and C) or P
Q3=(L and C) or N
Q4=N and D
Q5=Q4 or (L and Q3) or (P and C) or (L and C)
Q6=Q1 or (L and Q2) or (N and C) or (L and C)
wherein in the charging mode of the first positive half cycle signal, in the charging mode of the first negative half cycle signal, in the charging mode of the second positive half cycle signal, and in the charging mode of the second negative half cycle signal, the control circuit sets the charging pulse width modulation signal (C) to a high potential and the discharging pulse width modulation signal (D) to a low potential; in the discharging mode of the first positive half cycle signal, in the discharging mode of the first negative half cycle signal, in the discharging mode of the second positive half cycle signal, and in the discharging mode of the second negative half cycle signal, the control circuit sets the charging pulse width modulation signal (C) to a low potential and the discharging pulse width modulation signal (D) to a high potential; in the first positive half cycle signal of the first single-phase AC power of the three-phase AC input power and in the second positive half cycle signal of the first single-phase AC power of the three-phase AC input power, the control circuit sets the positive half cycle pulse width modulation signal (P) to a high potential and the negative half cycle pulse width modulation signal (N) to a low potential; in the first negative half cycle signal of the first single-phase AC power of the three-phase AC input power and in the second negative half cycle signal of the first single-phase AC power of the three-phase AC input power, the control circuit sets the positive half cycle pulse width modulation signal (P) to a low potential and the negative half cycle pulse width modulation signal (N) to a high potential; when the power measurement value (L) is a low potential, the control circuit sets the three bridge arm circuits to operate in the light load mode; when the power measurement value (L) is a high potential, the control circuit sets the three bridge arm circuits to operate in the heavy load mode.
